(19) United States
(12) Patent Application Publication
(10) Pub. No.: US 2013/0341334 A1
(43) Pub. Date: Dec. 26, 2013

(54) COOKING UTENSILS

(71) Applicant: IDENTITY WORKS, INC., West Salem, WI (US)

(72) Inventors: Jonathan J. Barth, La Crosse, WI (US); Thomas P. Hanchette, La Crosse, WI (US)

(73) Assignee: Identity Works, Inc., West Salem, WI (US)

(21) Appl. No.: 13/830,337

(22) Filed: Mar. 14, 2013

Related U.S. Application Data
(60) Provisional application No. 61/662,574, filed on Jun. 21, 2012.
(60) Provisional application No. 61/662,556, filed on Jun. 21, 2012.
(60) Provisional application No. 61/683,018, filed on Aug. 14, 2012.

(51) Int. Cl. A47J 43/28; A47G 21/10; A47G 21/02; A47G 21/04; A47J 27/00; B26B 3/02

(52) U.S. Cl. CPC A47J 43/28; A47J 27/002; B26B 3/02; A47G 21/02; A47G 21/04; A47G 21/10
USPC 220/573.1; 30/298.4; 30/323; 30/327; 294/7; 294/106

(57) ABSTRACT

A cooking utensil includes a handle having a proximal end and a distal end, a shaft having a first end in contact with the proximal end of the handle and a second end distal to the first end, the second end including a food contact implement. The proximal end of the handle includes a first and a second foot. The distal end of the handle includes a third foot. The first, second, and third foot are configured to elevate the handle from a surface and maintain the food contact implement in an elevated position when the cooking utensil is placed on the surface.

### CROSS-REFERENCE TO RELATED PATENT APPLICATIONS

This application claims priority from U.S. Provisional Patent Applications 61/662574, filed Jun. 21, 2012; 61/662556, filed Jun. 21, 2012; and 61/683018, filed Aug. 14, 2012, all of which are incorporated herein by reference in their entirety.

### FIELD

The present technology is generally related to cooking utensils. One aspect of the present technology is related to self-standing kitchen carving knives and self-standing knives used in eating. Another aspect of the present technology is related to self-standing lids for cookware and bakeware. Yet another aspect of the present technology is related to self-standing food preparation utensils used in cooking and grilling.

### BACKGROUND

Cooking utensils are currently designed in such a way that a portion of the utensil that contacts the food often comes into contact with countertop or tabletop surfaces when not in use, or between uses. By placing a cooking utensil on countertop or tabletop surfaces, sanitary and health issues arise that may result in making a mess on surfaces, potentially contaminating these surfaces or potentially contaminating the cooking utensil from contact with these surfaces.

For example, knives are often placed sideways on a countertop when cutting/carving or on a plate while eating. By placing the knife on its side sanitary, safety, and health issues may arise. For example, the knife may contaminate the countertop when its blade comes into contact with the countertop, or the countertop may contaminate the knife blade. Knives laid on the side of plates are often in the way and may inadvertently be knocked off the plate, causing a mess, damage, or even injury.

Similarly, lids for cookware and bakeware like skillets, pots, pans, and other cooking utensils that have separate lids are usually placed on countertops or stove tops while the cookware or bakeware is in use. For example, while frying meat in a skillet, the lid is taken off and set on the countertop while the meat is being stirred. Then the lid is placed back on the pot for further cooking. This creates many problems such as unstable placement of the lid that may fall causing injury or damage, taking up counterpace, placing a lid on an oven burner taking away space, damaging a countertop with a hot lid, etc. Additionally, a lid that is placed on a countertop may contaminate the countertop with bacteria, may soil the countertop with food residue or may contaminate the lid with bacteria

In another example, a basting brush may contaminate a countertop with a sauce or bacteria from the meat when bristles of the basting brush come into contact with the countertop, or the countertop may contaminate the basting brush with bacteria. Additionally, food preparation utensils laid on their side on a grill are often in the way of the food preparer, and they may inadvertently be knocked off the grill causing a mess, damage, or even injury.

### SUMMARY

An exemplary embodiment relates to a knife including a blade having a first face, a second face, and at least one cutting edge, and a handle having a proximal end and a distal end. The blade extends from the proximal end of the handle. The proximal end of the handle comprises at least one foot. The distal end of the handle comprises a second foot. The at least one foot and the second foot are configured to elevate the handle from a surface and maintain the blade in an elevated position when the knife is placed on the surface, with the cutting edge of the blade directed at, but not in contact with the surface, and the first face and second face substantially perpendicular to the surface.

Yet another exemplary embodiment relates to a cooking device including a cooking basin, a lid, and a handle. The handle includes a notch configured to receive an edge of the lid.

Yet another exemplary embodiment relates to a cooking utensil comprising includes a handle having a proximal end and a distal end, a shaft having a first end in contact with the proximal end of the handle and a second end distal to the first end, the second end including a food contact implement. The proximal end of the handle includes a first and a second foot. The distal end of the handle includes a third foot. The first, second, and third foot are configured to elevate the handle from a surface and maintain the food contact implement in an elevated position when the cooking utensil is placed on the surface.

### BRIEF DESCRIPTION OF THE DRAWINGS

FIG. 1 is an illustration of a self-standing knife in a perspective view, according to one embodiment.

FIG. 2 is an illustration of a self-standing knife in a perspective view including a surface upon which it rests, according to one embodiment.

FIG. 3 is an illustration of a self-standing knife in a perspective view, according to one embodiment.

FIG. 4 is a detailed illustration of a handle and serrated blade of a self-standing knife, according to one embodiment.

FIG. 5 is a detailed illustration of a handle and large blade of a self-standing knife, according to one embodiment.

FIG. 6 is an illustration of a lid management device in a side view, where the lid is not clipped into a handle, according to one embodiment.

FIG. 7 is an illustration of a lid of a lid management device perspective view, where the lid is disposed on the handle, according to one embodiment.

FIG. 8 is an illustration of a lid management device without the lid in a perspective view, according to one embodiment.

FIG. 9 is an illustration of the lid management device configured as a quart pot in a side view, according to one embodiment.

FIG. 10 is an illustration of the lid management device configured as a large pot in a side view, according to one embodiment.

FIG. 11 is a detailed illustration of a notch of a handle and a lid in the notch, according to one embodiment.

FIG. 12 illustrates how self-standing utensils stand up perpendicular to the tabletop in a perspective view, according to one embodiment.

FIG. 13 is an illustration of a self-standing utensil as a grilling fork in a side view, a top view of the food preparing end and also illustrates the surface it stands on, according to one embodiment.

FIG. 14 is an illustration of a self-standing utensil as a grilling spatula in a side view, a top view of the food preparing end and also illustrates the surface it stands on.

FIG. 15 is an illustration of a self-standing utensil as a basting brush in a side view, a top view of the food preparing end, and also the surface it stands on, according to one embodiment.

FIG. 16 is an illustration of a self-standing utensil as grilling tongs in a side view, how they open, the mechanics involved and also illustrates the surface it stands on, according to one embodiment.

FIG. 17 is a detailed illustration of a self-standing utensil as a blank utensil with no food preparation end in a side view, and it also illustrates the surface it stands on, according to one embodiment.

FIG. 18 is a detailed illustration of a variation of the design showing the self-standing utensils standing perpendicular to the tabletop in a perspectives view, with a knob added to the stem of each utensil so the food preparation end is held off the surface. The knob may be a necessary variation where the handles are made from lighter materials.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In one aspect, a self-standing knife is provided. The self-standing knife includes a blade and a handle, where the handle is configured to allow for the knife to rest on a hard surface with its cutting blade facing down toward the surface, i.e. perpendicular to the surface, without the blade touching the surface.

In another aspect, a lid management system for cookware is provided, wherein a handle of a cookware or bakeware item is configured to retain a lid by clipping the lid into the handle.

In yet another aspect, self-standing food preparation utensils used in cooking and grilling are provided, where a handle of a utensil is configured to allow the utensil to rest parallel to a surface while keeping the food preparing end from contacting the surface.

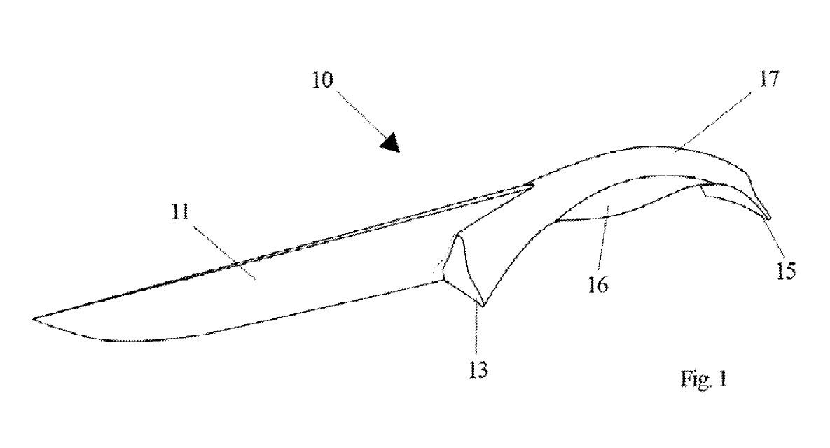

Referring now to the drawings, in FIG. 1, a self-standing knife (10) having a blade (11) and a handle (17) is illustrated in a left perspective view. The handle (17) includes a grip (16) disposed at a middle of the handle (17) for ease of grasping the self-standing knife (10) and for comfortable operation of the self-standing knife (10). Feet or opposite ends (13,15) of the handle (17) are stable (i.e., can be laid on a flat surface without tipping over) and hold the blade (11) perpendicular to a tabletop or cutting surface.

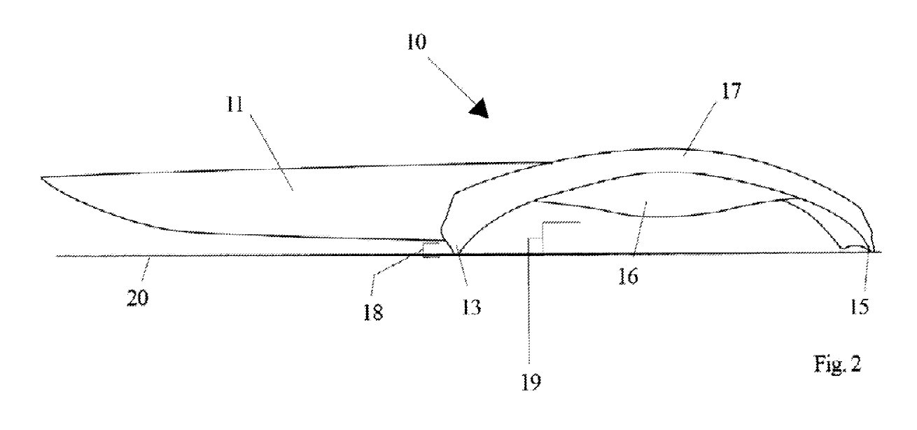

Referring now to FIG. 2, the blade (11) is raised off a cutting surface or tabletop surface (20) by a height (18) by virtue of the opposite ends (13,15) of the handle (17). The blade (11) is generally held perpendicular to the surface (20). The middle of the handle (17) (i.e., a portion where the grip (16) is located) is raised off of the cutting surface (20) by a height (19) by virtue of the handle (17) having an arc-shape and by the opposite ends (13,15) of handle (17).

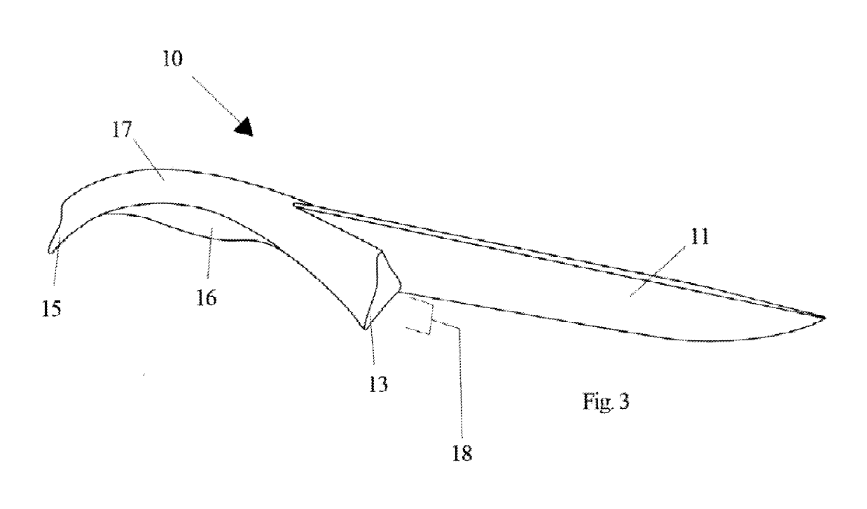

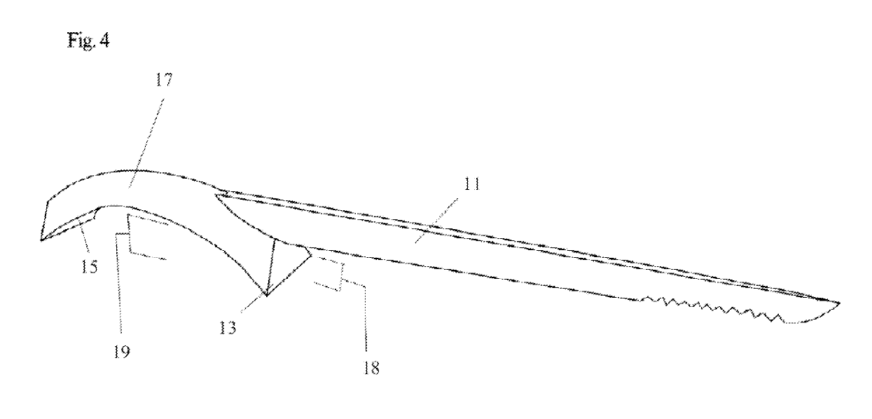

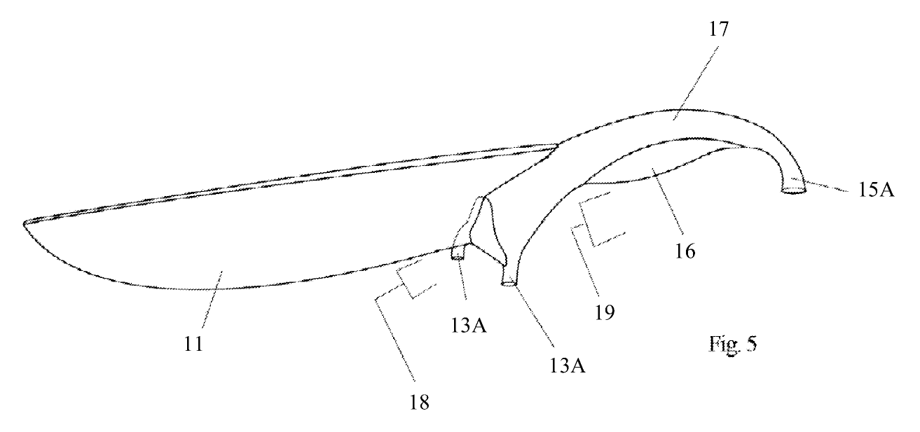

Referring generally to FIGS. 1-5, the blade (11) of the self-standing knife (10) may be made out of steel or any other sufficiently rigid material such as metals, ceramics, or hard plastics. Furthermore the handle (17) of the self-standing knife (10), including the handle components (13, 15, 16) can be made of different materials such as steel, other metals, wood, plastics, ceramics, silicone, and rubber.

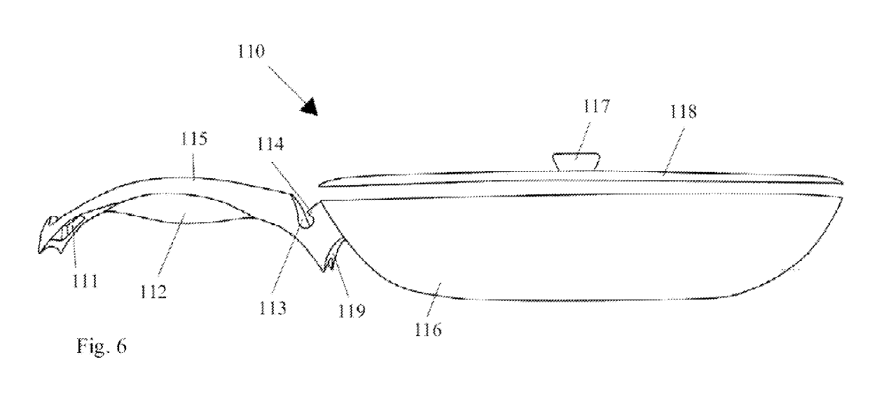

The handle (17) is sufficiently wide and long for comfortable grasping, holding and cutting. The blade (11) is sufficiently long and wide for its intended use. Length and width will vary depending on the purpose of each self-standing knife (10). For example, steak knives, meat carving knives (see FIG. 418), paring knives (see FIG. 6) will all have different sized handles (17) and blades (11), but in all cases the blade (11) is raised by the predetermined height (18) off of the surface (20) upon which it rests. The heights (18, 20) may vary depending on the purpose of each self-standing knife (10). In each self-standing knife (10), however, the blade (11) rests perpendicular to the resting or cutting surface (20) by virtue of the opposite ends (13, 15) of the handle (17). In one embodiment, the predetermined height is sufficient to allow a user to grasp the handle securely by being able to insert their fingers between the surface and the handle.

Although opposite ends (13, 15) are illustrated as generally solid or wedge-like pieces (see FIGS. 1, 3 and 4), in other embodiments, leg-like opposite ends (13A, 15A) can be provided.

In some embodiments, the handle (17) is weighted to assist in maintaining the elevation of the food preparation or contact end of the utensil. Accordingly, the handle (17) may include a weight within the handle. For example, the handle may be wood, plastic, or ceramic with a metal inside the handle. In other embodiments, the handle may be constructed from a metal to counterbalance the blade. The handle (17) may be primarily constructed of one or more materials for either aesthetic purposes or to provide for balancing of the utensil. As used herein, weighted is intended to mean that the handle is of such a mass or weight that the handle will counterbalance the blade of a knife, or the length of a spatula, tongs, or brush such that it is supported above the surface.

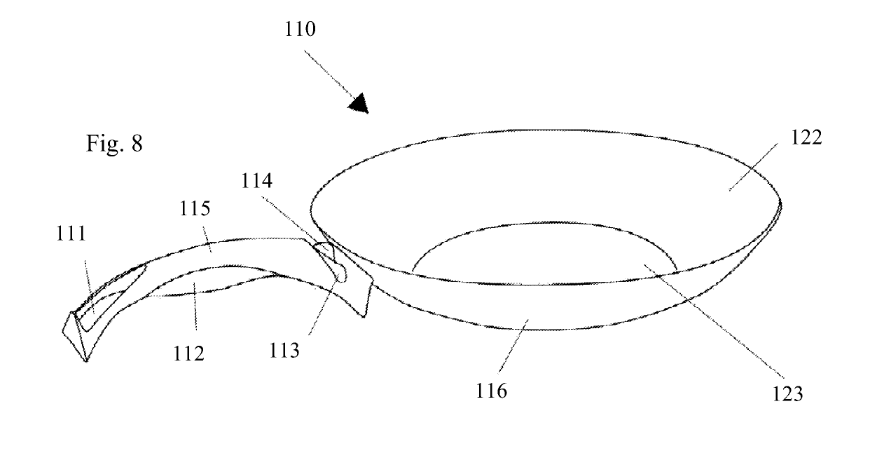

Referring now to FIGS. 6-8, a lid management device (110) having a skillet (116), a top or lid (118) and a handle (115) having a notch (113) in the handle (115) is illustrated. The notch (113) is disposed near the skillet (116) and is large enough for the lid (118) to fit securely into the notch (113). A lip (114) disposed in the handle (115) between the notch (113) and the skillet (116) helps secure the lid (118) into the notch (113). An aperture (111) may be disposed in the handle (115), at an end of the handle (115) opposite to an end at which the notch (113) is disposed, to allow the lid management device (110) to be hung.

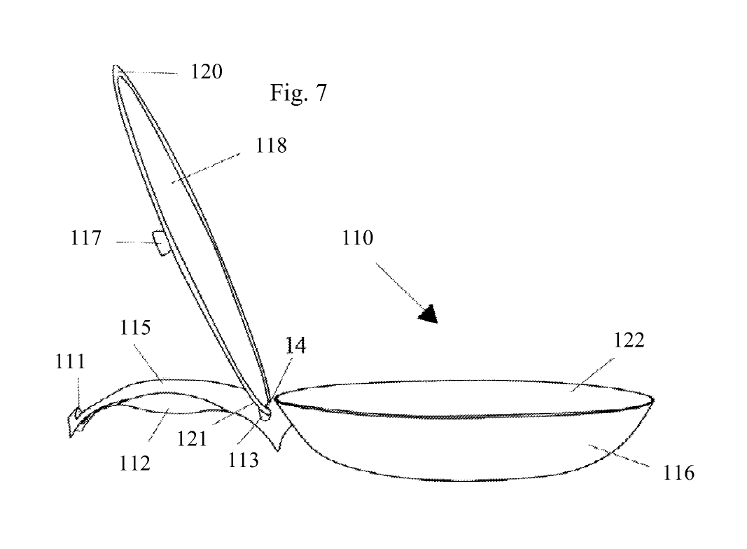

Referring now to FIG. 7, when the lid (118) is secured in the notch (113), the design of the notch (113) and gravity help hold the lid (118) in place. The lid (118) fits into the notch (113) in the handle (115) and the notch (113) holds the lid (118) upright or at an angle to the skillet (116). In one embodiment, the notch (113) is designed such that the lid (118) is held at an obtuse angle with respect to the skillet (116). When the lid (118) is secured or held in the notch (113) a cooking basin (122) of the skillet (116) can be used to receive food for cooking.

In addition to just using the design of the notch (113) and gravity to hold the lid (118) in place, the lid management device (110) may further include an additional securing agent (not illustrated) could be used such as a pressure fitting notch, a snap in system, a magnet, a spring-loaded button, etc. within the handle (115) to secure the lid (118) in varying degrees of firmness and angles with respect to the handle (115). In addition, a circumference (145) of the lid (118) may include a flange (121) configured to assist in securing the lid (118) in the notch (113) (see FIG. 7).

The lid (118) may include a protrusion (117) extending from a center of the lid (118) to help a user lift the lid (118) off of the skillet (116) without contacting a hot surface of the lid (118). The protrusion (117) may be made of an insulating material.

The handle (115) may include a grip (112) at a middle portion of the handle (115) for ease of grasping the handle (115) and for comfortable operation of the lid management device (110). The handle (115) may also include feet (119) that are stable (i.e., can be laid on a flat surface without tipping over) and hold the lid management device (110) at an angle to a tabletop or cutting surface.

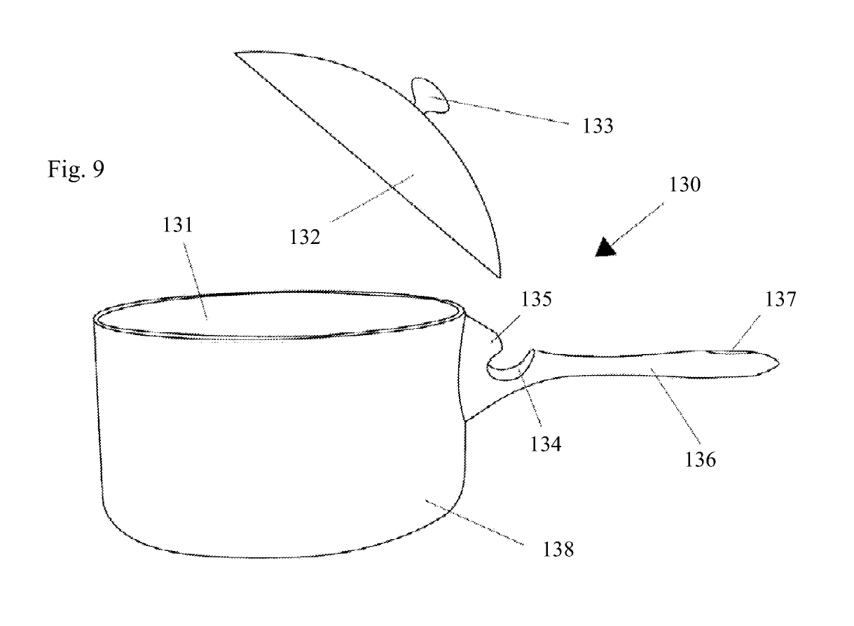

In other embodiments, the lid management device (110) may take the form of other cookware or bakeware. For example, FIG. 9 illustrates a lid management device (130) including a cooking pot (138) with a handle (136) that has a notch (134) disposed in the handle (136). A lid (132) fits into the notch (134) as described above in the embodiment of the lid management device (110). A lip (135) disposed in the handle (136) between the notch (134) and the cooking pot (138) helps secure the lid (132) into the notch (134). An aperture (137) may be disposed in the handle (136), at an end of the handle (136) opposite to an end at which the notch (134) is disposed, to allow the lid management device (130) to be hung. The lid (132) may include a protrusion (133) extending from a center of the lid (132) to help a user lift the lid (132) off of the cooking pot (138) without contacting a hot surface of the lid (132). The protrusion (133) may be made of an insulating material. When the lid (132) is secured or held in the notch (134) a cooking basin (131) of the cooking pot (138) can be used to receive food for cooking.

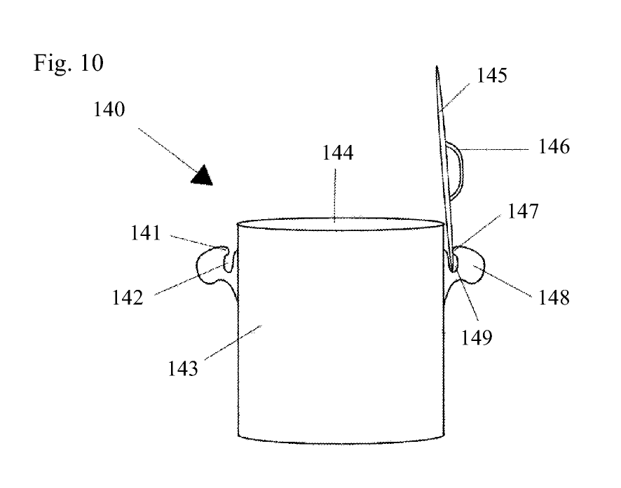

In another embodiment illustrated in FIG. 10, a lid management device (140) includes a large pot (143) having two handles (141, 148) disposed at opposite sides of the large pot (143). The handle (141) has a notch (142), and the handle (148) has a notch (149). The lid (145) fits into either of the notch (142,149) as described in the embodiment of the lid management device (110). A lip (147) disposed in either handle (141,148) helps secure the lid (145) into the notch (142, 149). The lid (145) may include a protrusion (146) extending from a center of the lid (145), to help a user lift the lid (145) off of the large pot (143) without contacting a hot surface of the lid (145). The protrusion (146) may be, for example, a handle made of an insulating material. When the lid (145) is secured or held in the notch (142,149) a cooking basin (144) of the large pot (143) can be used to receive food for cooking.

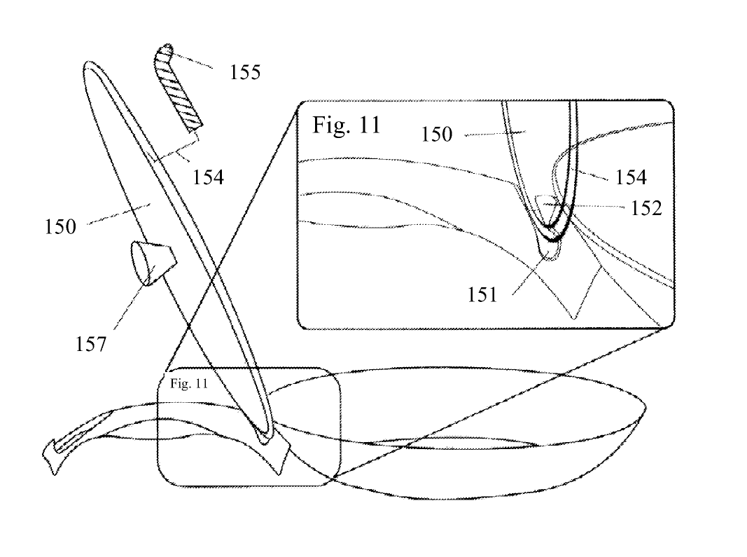

FIG. 11 illustrates a close-up view of a notch (151) of a handle used in a lid management device. A lid (150) fits into the notch (151), as described in the embodiments of the lid management devices (110,130,140) above. A circumference of the lid (150) has a flange (154). A cross section of the flange (154) illustrating a lip (155) of the flange (154) is also illustrated. The lip (155) will fit under a lip (152) in the handle, securing the lid (15) in the notch (151). The notch (151) and the lid (150) have similar curvatures in shape allowing the lid (150) and the lid's lip (155), to fit into the notch (151). The lid (150) may include a protrusion (157) extending from a center of the lid (150) to help a user lift the lid (150) without contacting a hot surface of the lid (150). The protrusion (157) may be made of an insulating material.

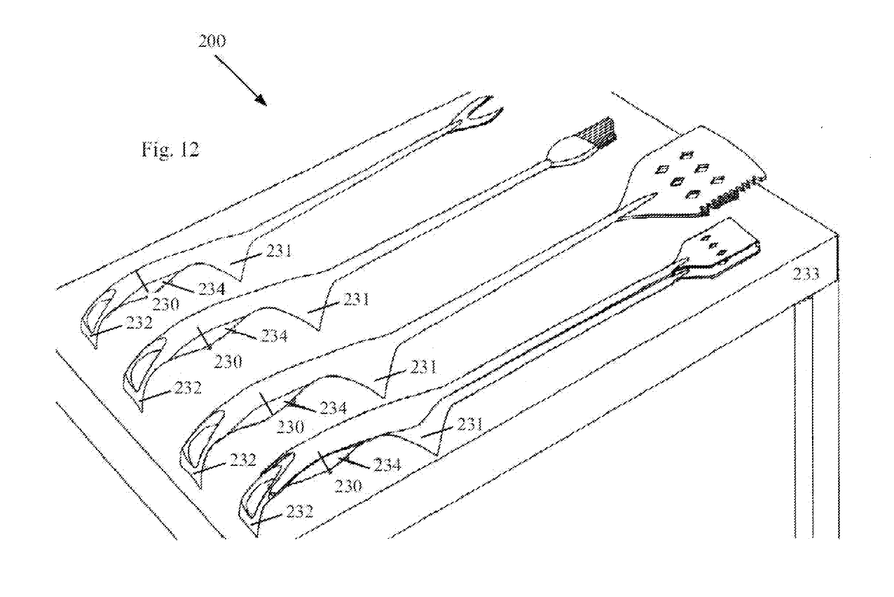

Referring now to FIG. 12, a barbeque grilling set (200) including a fork, a brush, a spatula and tongs, is illustrated in a perspective view. The handles (230) are sufficiently wide and long for comfortable food preparation. The handles (230) include a grips (234) disposed at a middle of the handle (230) for ease of grasping the utensils of the barbeque grilling set (200). Feet or opposite ends (231, 232) of the handle (230) are stable (i.e., can be laid on a flat surface without tipping over) and hold the utensils of the barbeque grilling set (200) parallel to a tabletop or cutting surface (233).

Referring generally to FIGS. 12-18, the self-standing utensils of the barbeque grilling set (200) may be made out of steel or any other sufficiently rigid material such as metals, ceramics, or hard plastics. Furthermore the handles (230) of the self-standing utensils of the barbeque grilling set (200) and the handles components such as the grip (234) can be made of different materials such as steel, other metals, wood, plastics, ceramics, silicone, and rubber. The handle (230) of each of the self-standing utensils of the barbeque grilling set (200) is sufficiently wide and long for comfortable holding and preparing of food.

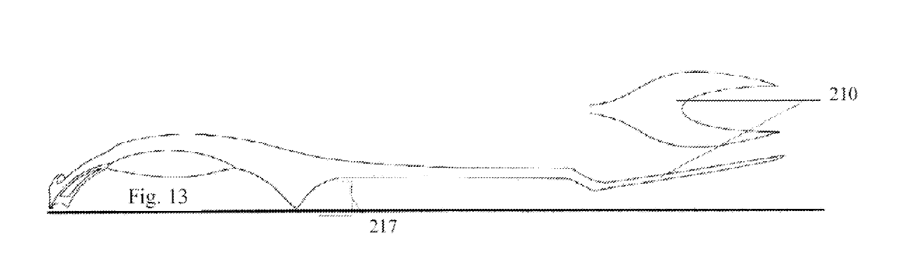

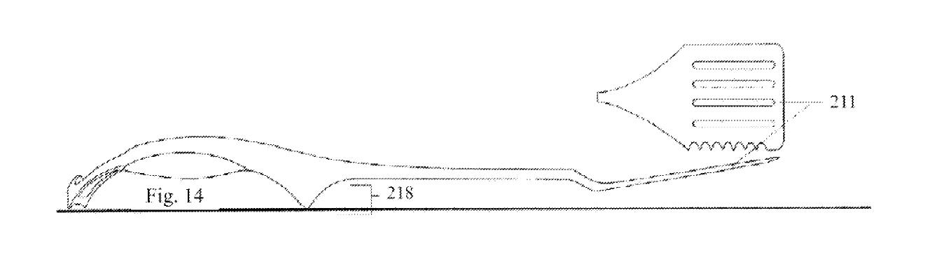

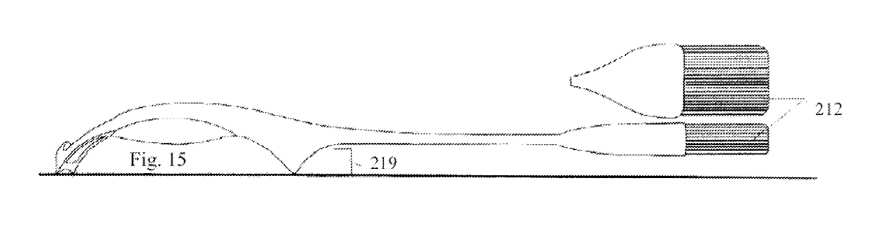

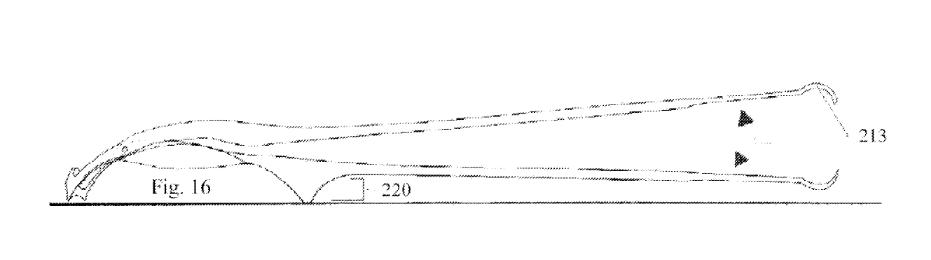

Referring now to FIGS. 13-17, length, width and food preparation ends (210,211,212,213,241) will vary depending on the purpose of each utensil. For example a barbeque fork (210), tongs (213), brush (212), spatula (211), skewers (not illustrated), meat hooks (not illustrated), etc. may all have different sized handles and food preparation ends depending on whether the intended use is an outside barbeque station or an inside kitchen area. In all cases, however, the food preparation end is raised a predetermined height off of the surface (233) by virtue of the opposite ends of feet (231). For example, in FIG. 13, the barbeque fork (210) is raised a height (217) off of the surface (233). In FIG. 14, the spatula (211), is raised a height (218) off of the surface (233). In FIG. 15, the brush (212) is raised a height (219) off of the surface (232). In FIG. 16, the tongs (213) are raised a height (220) off of the surface (233).

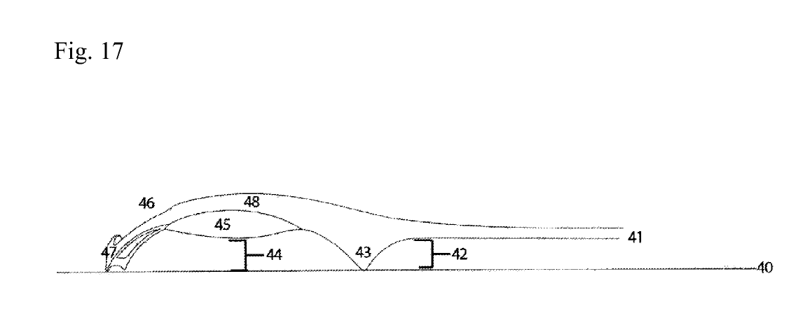

Referring now to FIG. 17, the self-standing utensil handle (48) is elevated a height (44) above the tabletop (40) by virtue of the curvature of the handle (48) and the opposite ends or feet (43, 47) of the handle (48). The food preparation end (41) is elevated a height (42) off the tabletop (40) by virtue of the opposite ends or feet (43, 47) of the handle (48). The handle (48) include a grip (45) disposed at a middle of the handle (48) for ease of grasping the utensil. An aperture (46) may be disposed in the handle (48) to allow the utensil to be hung. The food preparation end (41) is sufficiently long and wide for its intended use.

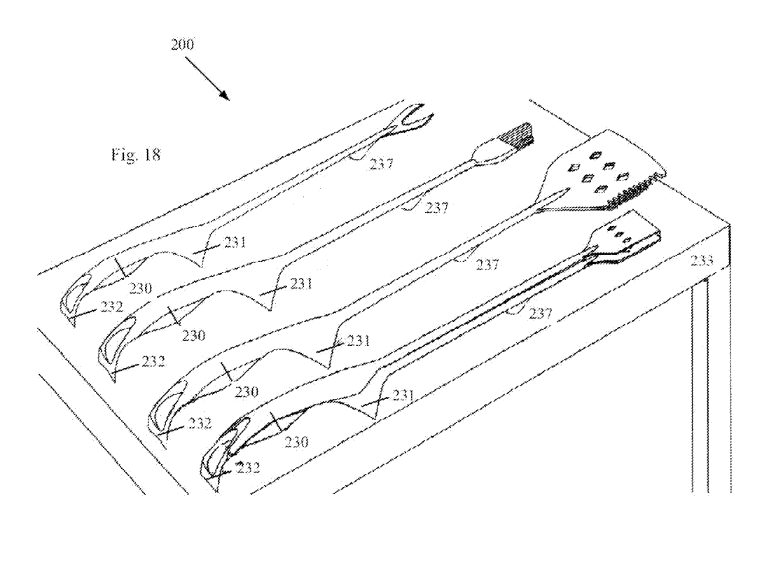

Referring now to FIG. 18, the utensils of the barbeque grilling set 200 may further include a knob (237) configured to further raise and/or support the food preparation ends of the utensils off the tabletop surface (233). The knobs (237) assist the handles (230) in keeping the food preparation ends off the surface (233) if the handles (230) are made from a lighter material or the stems are too long for the handle (230) to bear the weight of the utensil end.

In some embodiments, the handle (230) is weighted to assist in maintaining the elevation of the food preparation or contact end of the utensil. Accordingly, the handle (230) may be constructed of metal, wood, plastics, ceramics, and the like. The handle (230) may be primarily constructed of one or more materials for either aesthetic purposes or to provide for balancing of the utensil.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

What is claimed is:

1. A knife comprising:
a blade comprising:
a first face;
a second face; and
at least one cutting edge; and
a handle comprising:
a proximal end; and
a distal end;
wherein:
the blade extends from the proximal end of the handle;
the proximal end of the handle comprises at least one foot;
the distal end of the handle comprises a second foot;
the at least one foot and the second foot are configured to elevate the handle from a surface and maintain the blade in an elevated position when the knife is placed on the surface, with the cutting edge of the blade directed at, but not in contact with the surface, and the first face and second face substantially perpendicular to the surface.

2. The knife of claim 1, wherein the handle further comprises a grip.

3. The knife of claim 1, wherein the handle is formed in an arc shape such that a middle portion of the handle, located between the proximal end and the distal end, is elevated from the surface.

4. The knife of claim 1, wherein the handle is weighted.

5. A cooking device comprising:
a cooking basin;
a lid; and
a handle,
wherein the handle comprises a notch configured to receive an edge of the lid.

6. The cooking device of claim 5, wherein the handle further comprising an aperture configured for hanging storage of the cooking device.

7. The cooking device of claim 5, wherein the notch is configured to retain the lid in a substantially perpendicular orientation in relation to the handle.

8. The cooking device of claim 5, wherein the handle further comprises a grip.

9. The cooking device of claim 5, wherein the handle is formed in an arc shape such that a middle portion of the handle is elevated from the surface upon which the cooking device is placed.

10. The cooking device of claim 5, wherein the handle further comprises a lip configured to assist in securing the lid in the notch.

11. The cooking device of claim 5, wherein the cooking device is a skillet, a pot, or a pan.

12. A cooking utensil comprising:
a handle comprising:
a proximal end; and
a distal end; and
a shaft comprising:
a first end in contact with the proximal end of the handle; and
a second end distal to the first end, the second end comprising a food contact implement;
wherein:
the proximal end of the handle comprises a first and a second foot;
the distal end of the handle comprises a third foot;
the first, second, and third foot are configured to elevate the handle from a surface and maintain the food contact implement in an elevated position when the cooking utensil is placed on the surface.

13. The cooking utensil of claim 12, further comprising a knob near the second end of the shaft and configured to assist in maintaining the food contact implement in an elevated position with respect to the surface.

14. The cooking utensil of claim 12, wherein the cooking implement is a spatula, a brush, a spoon, a fork, or a tongs.

15. The cooking utensil of claim 12, wherein the handle further comprises a grip.

16. The cooking utensil of claim 12, wherein the handle is formed in an arc shape such that a middle portion of the handle, located between the proximal end and the distal end, is elevated from the surface.
